(19) United States
(12) Patent Application Publication
(10) Pub. No.: US 2014/0273995 A1
(43) Pub. Date: Sep. 18, 2014

(54) ALARM METHOD AND APPARATUS FOR MOBILE COMMUNICATION TERMINAL

(71) Applicant: Samsung Electronics Co., Ltd., Suwon-si (KR)

(72) Inventors: Nam-Hoon KIM, Suwon-si (KR); Jeong-Gwan KANG, Hwaseong-si (KR); Hyun-Su HONG, Seongnam-si (KR)

(73) Assignee: Samsung Electronics Co., Ltd., Suwon-si (KR)

(21) Appl. No.: 14/180,973

(22) Filed: Feb. 14, 2014

(30) Foreign Application Priority Data
Mar. 12, 2013 (KR) 10-2013-0026316

(51) Int. Cl. H04M 3/42; H04W 4/16

(52) U.S. Cl. CPC H04M 3/42365; H04M 3/42348; H04W 4/16
USPC 455/414.1

(57) ABSTRACT

A method for executing an alarm in a mobile communication terminal is provided. The alarm method includes determining whether a call request reject occurs, detecting at least one of preset schedule information, motion information of the mobile communication terminal, and location information of the mobile communication terminal from the time of the determining that the call request reject occurs, and executing an alarm that recommends a user to call a corresponding caller of the call request reject based on the detected at least one information.

### CROSS-REFERENCE TO RELATED APPLICATION(S)

This application claims the benefit under 35 U.S.C. §119(a) of a Korean patent application filed on Mar. 12, 2013 in the Korean Intellectual Property Office and assigned Serial number 10-2013-0026316, the entire disclosure of which is hereby incorporated by reference.

### TECHNICAL FIELD

The present disclosure relates to an alarm technique. More particularly, the present disclosure relates to an alarm method and apparatus for a mobile communication terminal having a phone call function.

### BACKGROUND

Currently, for mobile communication terminals such as cellular phone, smart phones, tablet Personal Computers (PCs), Personal Digital Assistants (PDAs), and any other similar and/or suitable devices, various techniques have been developed and applied to help users remember important information or to inform the users of specific actions that the users have to perform. For example, the users often use an alarm to be alerted at a particular time or use an alarm such as a wake-up call.

For a mobile communication terminal having a phone call function, a technique for informing a user of a missed call the user fails to recognize is applied. In addition, if a user receives a call in a situation where the user cannot receive the call (for example, when the user participates in a conference or class, watches a movie, or concentrates on other tasks), the user may reject or decline the call. Recently, techniques have also been developed and implemented which send a text message to the caller indicating that the user cannot receive the call instead of rejecting the call on a case by case basis (for example, according to whether the user knows the caller or not).

A technique of the related art for an alarm function of a mobile communication terminal is disclosed in US Patent Publication No. 2011-0076989, entitled “Missed Communication Handling”, invented by Lynch, Stephen, and Brian, filed by an Apple Inc., and published on Mar. 31, 2011. US Patent Publication No. 2011-0076989 discloses a technique in which when a call is received by a user, the user may select not to receive the call and to receive an alarm corresponding to the call after a predetermined time has elapsed or if a predetermined condition is satisfied.

With the technique for receiving an alarm corresponding to the call after a predetermined time has elapsed or if a predetermined condition is satisfied, instead of intentionally not receiving the call, information related to the user's current state cannot be delivered to the caller. Moreover, according to the technique for sending a text message indicating that the user cannot receive a call after sending a text message saying “I'm not available now. I′ll call you back.”, the user may not remember to contact the caller.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an alarm method and apparatus for a mobile communication terminal to prevent a user from forgetting to contact a caller after rejecting an incoming call or expressing an intention to call the caller back with a call reject message.

Another aspect of the present disclosure is to provide an alarm method and apparatus for a mobile communication terminal to remind a user to return a call from a caller back in case that the user forgets to call the caller back after the user becomes available, if the user rejects the incoming call or sends a call reject message to the caller when the user in unable to receive the call.

In accordance with an aspect of the present disclosure, a method for executing an alarm in a mobile communication terminal is provided. The method includes determining whether a call request reject occurs, detecting at least one of preset schedule information, motion information of the mobile communication terminal, and location information of the mobile communication terminal from the time of the determining that the call request reject occurs, and executing an alarm that recommends a user to call a caller of the call request reject based on the detected at least one information.

In accordance with another aspect of the present disclosure, an apparatus for executing an alarm in a mobile communication terminal is provided. The apparatus includes a communication module configured to transmit and receive a wireless signal and a controller configured to sense rejection of a call request signal of a caller received by the communication module, to detect at least one of preset schedule information, motion information of the mobile communication terminal, and location information of the mobile communication terminal from the time of the sensed rejection, and to execute an alarm that recommends a user to call the caller based on the detected at least one information.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of a mobile communication terminal that executes an alarm operation according to an embodiment of the present disclosure;

FIG. 2 is a flowchart illustrating an alarm operation of a mobile communication terminal according to an embodiment of the present disclosure;

FIG. 3 is a diagram illustrating a screen for sending a call reject message according to an embodiment of the present disclosure; and

FIG. 4 is a diagram illustrating a screen in which an alarm inviting a user to call a caller is executed as a mobile communication terminal operates, according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

FIG. 1 is a block diagram of a mobile communication terminal that executes an alarm operation according to an embodiment of the present disclosure.

Referring to FIG. 1, the mobile communication terminal 100 may include a controller 110, a mobile communication module 120, a sub-communication module 130, a multimedia module 140, a camera module 150, a Global Positioning System (GPS) module 155, an Input/Output (I/O) module 160, a sensor module 170, a storage unit 175, and a power supply unit 180. The sub-communication module 130 includes at least one of a Wireless Local Area Network (WLAN) module 131 and a short-range communication module 132. The multimedia module 140 includes at least one of a broadcast communication module 141, an audio playback module 142, and a video playback module 143. The camera module 150 may include at least one of a first camera 151 and a second camera 152. The I/O module 160 may include at least one of a button 161, a microphone 162, a speaker 163, a vibration motor 164, a connector 165, a keypad 166, and an earphone connecting jack 167. The following description will be made based on an example in which a display 190 and a display controller 195 are a touch screen and a touch screen controller, respectively.

The power supply unit 180 supplies power to one or more batteries (not illustrated) disposed in a housing of the mobile communication terminal 100. The one or more batteries (not illustrated) supply power to the mobile communication terminal 100. The power supply unit 180 may also supply power input from an external power source (not illustrated) through a wired cable connected with the connector 165 to the mobile communication terminal 100. The power supply unit 180 may also supply power to the mobile communication terminal 100 that is wirelessly input from an external power source using a wireless charging technique.

The camera module 150 may include at least one of the first camera 151 and the second camera 152 that capture a still image or a video under control of the controller 110.

The multimedia module 140 may include the broadcast communication module 141, the audio playback module 142, or the video playback module 143. The broadcast communication module 141 receives a broadcast signal (for example, a TeleVision (TV) broadcast signal, a radio broadcast signal, or a data broadcast signal) and broadcast additional information (for example, an Electric Program Guide (EPG) or an Electric Service Guide (ESG)) transmitted from a broadcasting station via a broadcast communication antenna (not illustrated). The audio playback module 142 plays a digital audio file (for example, a file having a file extension such as ‘mp3’, ‘wma’, ‘ogg’, or ‘wav’) stored or received under control of the controller 110. The video playback module 143 plays a digital video file (for example, a file having a file extension such as ‘mpeg’, ‘mpg’, ‘mp4’, ‘avi’, ‘mov’, or ‘mkv’) stored or received under control of the controller 110. The video playback module 143 may also play a digital audio file.

The multimedia module 140 may include the audio playback module 142 and the video playback module 143 while excluding the broadcast communication module 141. The audio playback module 142 or the video playback module 143 of the multimedia module 140 may be integrated into the controller 110.

The mobile communication module 120 may facilitate the connection between the mobile communication terminal 100 and an external device using one or more antennas (not illustrated). The mobile communication module 120 transmits and receives a wireless signal for a voice call, a video call, a text message (e.g., Short Messaging Service (SMS)), and/or a multimedia message (e.g., Multimedia Messaging Service (MMS)) with a cellular phone (not illustrated), a smart phone (not illustrated), a tablet PC, or another electronic device (not illustrated) which has a phone number input into the mobile communication terminal 100. The mobile communication module 120 may be connected to the Internet or wirelessly transmit and/or receive a wireless signal with neighboring devices in a place where a wireless Access Point (AP) is installed that is configured to receive Wi-Fi, a 3^{rd} Generation (3G)/4^{th} Generation (4G) data network, or the like.

The sub-communication module 130 may include at least one of the WLAN module 131 and the short-range communication module 132.

The WLAN module 131 may be connected to the Internet via a wireless Access Point (AP) (not illustrated). The WLAN module 131 supports any suitable wireless LAN standard by the Institute of Electrical and Electronics Engineers (IEEE) such as IEEE802.11n and/or IEEE802.11ac. The short-range communication module 132 wirelessly performs short-range communication between the mobile communication terminal 100 and an external electronic device.

The mobile communication terminal 100, depending on its capability, may include at least one of the mobile communication module 120, the WLAN module 131, and the short-range communication module 132, and may be referred to as a communication module. For example, the mobile communication terminal 100 may include a combination of the mobile communication module 120, the WLAN module 131, and the short-range communication module 132, depending on its capability.

The GPS module 155 receives electric waves from a plurality of GPS satellites (not illustrated) in the Earth's orbit, and calculates a location of the mobile communication terminal 100 by using a time of arrival from the GPS satellite (not illustrated) to the mobile communication terminal 100.

The sensor module 170 may include at least one sensor that detects a status of the mobile communication terminal 100. For example, the sensor module 170 may include a proximity sensor for detecting the user's proximity with respect to the mobile communication terminal 100, a motion sensor (not illustrated) for detecting motion of the mobile communication terminal 100 (for example, rotation of the mobile communication terminal 100 or acceleration or vibration applied to the mobile communication terminal 100), an illumination sensor (not illustrated) for detecting an amount of light incident to the mobile communication terminal 100, a gravity sensor for detecting a direction of gravity, and an altimeter for measuring an atmospheric pressure to detect an altitude. The sensor module 170 may also include a geo-magnetic sensor (not illustrated) for detecting a point of the compass by using the Earth's magnetic field and an inertia sensor for measuring an angular displacement or a rate of change of the angular displacement in a predetermined direction.

The sensor of the sensor module 170 may be added or removed depending on the capability of the mobile communication terminal 100. The at least one sensors may detect the status of the mobile communication terminal 100, generate a signal corresponding to the detection, and deliver the generated signal to the controller 110.

The I/O module 160 may include at least one of a button 161, the microphone 162, the speaker 163, the vibration motor 164, the connector 165, and the keypad 166.

The button 161 includes at least one button and may be formed on at least one of a front surface, a side surface, and a rear surface of the housing of the mobile communication terminal 100, and may include at least one of a power/lock button (not illustrated), a volume button (not illustrated), a menu button, a home button, a back button, and a search button.

The microphone 162 receives voice or sound and generates a corresponding electric signal under control of the controller 110.

The one or more speakers 163 may be formed in a suitable position or suitable positions of the housing of the mobile communication terminal 100. The speaker 163 outputs sound corresponding to various signals of the mobile communication module 120, the sub-communication module 130, the multimedia module 140, or the camera module 150 (for example, a wireless signal, a broadcast signal, a digital audio file, a digital video file, a captured picture, or the like). The speaker 163 outputs sounds corresponding to various functions executed by the mobile communication terminal 100 (for example, a button manipulation sound corresponding to a phone call, a ring back tone, and any other similar and/or suitable sounds). The speaker 163 may output a preset voice or a preset sound as an alarm for inviting the user to call a caller, based on alarm operation characteristics of the mobile communication terminal 100 according to the present disclosure.

The vibration motor 164 converts an electric signal into mechanical vibration. For example, when a voice call is received at the mobile communication terminal 100 in a vibration mode from another device (not illustrated), the vibration motor 164 may operate. The vibration motor 164 may one or more vibration motors that are disposed in the housing of the mobile communication terminal 100. The vibration motor 164 may operate in response to a user's touch on the touch screen 190 or a continuous movement of a touch on the touch screen 190. The vibration motor 164 may operate to generate a preset vibration as an alarm inviting the user to call the previous caller based on the alarm operation characteristics of the mobile communication terminal 100 according to the present disclosure.

The connector 165 may be used as an interface for connecting the mobile communication terminal 100 with an external device (not illustrated) or a power source (not illustrated). Data stored in the storage unit 175 of the mobile communication terminal 100 may be transmitted to an external electronic device or data may be received from the external electronic device through a wired cable connected to the connector 165. The mobile communication terminal 100 receives power from the power source (not illustrated) through the wired cable connected to the connector 165 or charges a battery (not illustrated) by using the power source.

The keypad 166 receives key input from the user for control of the mobile communication terminal 100. The keypad 166 includes a physical keypad (not illustrated) formed in the mobile communication terminal 100 or a virtual keypad (not illustrated) displayed on the touch screen 190. The physical keypad (not illustrated) formed in the mobile communication terminal 100 may be excluded according to the capability or structure of the mobile communication terminal 100.

An earphone (not illustrated) may be inserted into the earphone connecting jack 167 to be connected to the mobile communication terminal 100.

The touch screen 190 receives user manipulation and displays an image corresponding to execution of applications, and operation and menu states of the mobile communication terminal 100. That is, the touch screen 190 may provide a User Interface (UI) corresponding to various services (for example, a phone call, data transmission, broadcasting, picture capture, and so forth) to users. The touch screen 190 delivers an analog signal, which corresponds to at least one touch input to the UI, to the touch screen controller 195. The touch screen 190 receives at least one user input through a user's body (for example, a finger including a thumb) or a touchable input means (for example, a stylus pen or an electronic pen). The touch screen 190 also receives a continuous movement of one of at least one touch. The touch screen 190 delivers an analog signal corresponding to the received continuous movement of the touch to the touch screen controller 195.

In the present disclosure, a touch may also include a non-contact touch between the touch screen 190 and the user's body or the touchable input means. A detectable distance or interval from the touch screen 190 may be changed according to the capability or structure of the mobile communication terminal 100. In particular, to separately detect a touch event based on a contact with the user's body or the touchable input means and an input event based on a non-contact state (for example, a hovering event), the touch screen 190 may be configured to output different values (for example, an electric-current value or the like) corresponding to the touch event and the hovering event. The touch screen 190 may also output different values (for example, an electric-current value or the like) based on a distance between the touch screen 190 and a space where the hovering event occurs.

The touch screen 190 may be implemented as, for example, a resistive type, a capacitive type, an infrared type, an acoustic wave type, or the like.

The touch screen controller 195 converts the analog signal received from the touch screen 190 into a digital signal (for example, X and Y coordinates) and delivers the digital signal to the controller 110. The controller 110 controls the touch screen 190 by using the digital signal received from the touch screen controller 195. For example, the controller 110 may control a shortcut icon (not illustrated) that is displayed on the touch screen 190 and configured to be selected or executed in response to a touch event or a hovering event. The touch screen controller 195 may be included in the controller 110.

The touch screen controller 195, by detecting a value (for example, an electric-current value) output through the touch screen 190, recognizes a distance between the touch screen 190 and where the hovering event occurs, and converts the recognized distance into a digital signal (for example, a Z coordinate) and then sends the digital signal to the controller 110.

The touch screen controller 195 may include at least two touch panels capable of sensing a touch input or an approach of the user's body and the touchable input means to simultaneously receive inputs generated by the user's body and the touchable input means. The at least two touch panels provide different output values to the touch screen controller 195. The touch screen controller 195 recognizes the different values input from the at least two touch screen panels to identify whether the input generated by the user's body or the touchable input means. The touch screen 190 may display a visual indication corresponding to the alarm operation inviting the user to call the previous caller (for example, output a preset screen or a pop-up window).

The storage unit 175 stores a signal or data that is input/output corresponding to operations of the communication module 120, the sub-communication module 130, the multimedia module 140, the camera module 150, the GPS module 155, the input/output module 160, the sensor module 170, and the touch screen 190. The storage unit 175 may also store a control program and applications for control of the mobile communication terminal 100 and/or the controller 110.

The term “storage unit” includes the storage unit 175, a Read Only Memory (ROM) and a Random Access Memory (RAM) integral to the controller 110, or a memory card mounted in the mobile communication terminal 100 (not illustrated) (for example, a Secure Digital (SD) card, a memory stick, or the like). The storage unit 175 may include a non-volatile memory, a volatile memory, a Hard Disk Drive (HDD), or a Solid State Drive (SSD).

The controller 110 may integrate a Central Processing Unit (CPU), a ROM in which a control program for controlling the mobile communication terminal 100 is stored, and a RAM which stores a signal or data input from the outside of the mobile communication terminal 100 or is used as a memory region for a task performed in the mobile communication terminal 100. The CPU may include any suitable number of processing cores such as a single core, a dual core, a triple core, or a quad core processor. The CPU, the ROM, and the RAM may be interconnected through an internal bus.

The controller 110 controls the communication module 120, the sub-communication module 130, the multimedia module 140, the camera module 150, the GPS module 155, the I/O module 160, the sensor module 170, the storage unit 175, the power supply unit 180, the touch screen 190, and the touch screen controller 195.

The controller 110, based on the alarm operation characteristics according to the present disclosure, controls an operation of sensing rejection of a call request signal that is generated from the caller that is received by the communication module, and an operation of detecting at least one of preset schedule information, motion information of the mobile communication terminal 100, and location information of the mobile communication terminal 100 from the time (or point-in-time) of sensing rejection of the call request signal. The controller 110 may also control an operation of executing a preset alarm operation that recommends the user to call the previous caller based on the detected at least one information.

The controller 110 controls an operation of sensing call request rejection when a reception reject message (or a call reject message) is sent to a caller using a preset user manipulation, for example, a touch input, a voice input, or any other similar and/or suitable manipulation. The controller 110 also controls an operation of sensing call request rejection when a call reject message is sent to a caller using a preset user manipulation, for example, a touch input, a voice input, or any other similar and/or suitable manipulation, if a phone number of the caller is stored in advance in the mobile communication terminal 100.

According to the present disclosure, the controller 110 controls the preset alarm, which invites the user to call the previous caller, to not be executed if a call log associated with the caller is detected.

According to the present disclosure, the controller 110 also controls the alarm to be executed if a preset time has elapsed since rejection of the call request signal of the previous caller was sensed.

According to the present disclosure, the controller 110 also controls the alarm to not be executed if the call log associated with the caller is detected before the elapse of the preset time from the time of sensing rejection of the call request signal generated from the caller.

FIG. 2 is a flowchart illustrating alarm operations of the mobile communication terminal 100 according to an embodiment of the present disclosure.

Referring to FIG. 2, if the user sends a call reject message in response to a call request signal, a user's situation is recognized, and if the user's situation has changed such that the user is capable of making a call, the present disclosure executes an alarm operation that recommends the user to call the previous caller who received the call reject message. If the present disclosure fails to recognize the user's situation, it may execute the alarm operation that recommends the user to call the previous caller after a preset time has elapsed. If the user has already received another call from the previous caller without a call rejection or has already made a call to the caller before the alarm is executed, the present disclosure may control the alarm not to be executed.

In operation 201, it is determined whether a call request signal is generated from a caller. Based on a result of the determination in operation 201, more specifically, if the call request signal is generated from the caller, operation 203 is performed; otherwise, if the call request signal is not generated from the caller, operations of the present disclosure are not performed.

In operation 203, it is determined whether to send a call reject message to the caller. If the call reject message is sent to the caller, reception of the call request signal is automatically terminated.

FIG. 3 is a diagram illustrating a screen for sending a call reject message according to an embodiment of the present disclosure.

Referring to FIG. 3, using a preset user manipulation such as a touch input, a voice input, or any other similar and/or suitable manipulation, the user may select a preset call reject message phrase or create a new message and send the call reject message to the caller in response to the call request signal. If it is determined to send the call reject message to the caller in operation 203, operation 205 is performed. Otherwise, if it is determined not to send the call reject message to the caller in operation 203, the operations of the present disclosure are terminated.

In operation 205, it is confirmed that the call reject message is sent. In operation 207, a time that has elapsed since the call reject message was sent is determined. The time of sending the call reject message coincides with the time of confirming that the call reject message is sent.

In operation 209, it is determined whether a preset time has not elapsed since the call reject message was sent. Based on a result of the determination in operation 209, more specifically, if the preset time has not elapsed from the time of sending the call reject message, operation 211 is performed. Otherwise, if the preset time has elapsed from the time of sending the call reject message, operation 215 is performed.

In operation 211, it is determined whether there is a call log associated with the caller. If it is determined that there is no call log associated with the caller, operation 213 is performed. Otherwise, if there is a call log associated with the caller, operation 215 is performed.

In operation 213, it is determined whether there is a motion of the mobile communication terminal 100. The determination may be performed by sensing a motion or movement of the mobile communication terminal 100 by using, for example, an inertia sensor, a geomagnetic sensor, a GPS, or any other similar and/or suitable device. More specifically, after the preset time has elapsed from the time of sending the call reject message, a motion of the mobile communication terminal 100 is sensed and determined. When the user puts down the mobile communication terminal 100 after sending the call reject message, such an action may be mistakenly regarded as a motion of the mobile communication terminal 100, causing a malfunction. For this reason, the motion of the mobile communication terminal 100 is sensed and determined after the elapse of the preset time.

If it is determined that there is a motion of the mobile communication terminal 100 in operation 213, operation 215 is performed; otherwise, if it is determined that there is no motion of the mobile communication terminal 100 in operation 213, operation 207 is performed.

In operation 215, caller information, for example, caller's name and phone number (the caller's phone number if the caller is not stored in a phone directory list) and the time at which the call comes in, is identified. In operation 217, an alarm operation is executed that recommends the user to call the previous caller. The alarm operation may include at least one of an operation of visually displaying an indication on a screen of the mobile communication terminal 100, an operation of providing a vibration, an operation of outputting a predetermined voice, and an operation of outputting a predetermined sound. The operation of visually displaying the indication on the screen of the mobile communication terminal 100 may be, for example, an operation of generating a pop-up window recommending the user to call the previous caller which includes a phone button for directly making a call to the previous caller, as illustrated in FIG. 4. The operation of visually displaying the indication on the screen of the mobile communication terminal 100 may also include displaying the time at which the previous call was received and the name of the caller.

FIG. 4 is a diagram illustrating a screen in which an alarm inviting a user to call a caller is executed as a mobile communication terminal operates, according to an embodiment of the present disclosure.

While the operations of the present disclosure corresponding to sending of the call reject message have been described in the foregoing embodiment, sending of the call reject message is included in a call request reject event such that the operations of the present disclosure may also be performed when the user rejects the call according to user's settings.

The structure and operations of the alarm method and apparatus for the mobile communication terminal according to the present disclosure may be made as described above, and while detailed various embodiments have been described in the foregoing description of the present disclosure, other various embodiments, modifications, and changes of the present disclosure may be made. For example, operations described may be simultaneously performed in parallel, in whole or in part, some may be omitted, or other additional operations may be further included.

For example, the operation of confirming that the call reject message is sent (an operation of confirming that the call request reject event occurs) in operation 205 may be performed when the caller's phone number is stored in advance in the user's mobile communication terminal, instead of confirming every sending of the call reject message (every occurrence of the call request reject event). For example, callers whose phone numbers are stored in advance in the phone directory of the mobile communication terminal of the user may be managed and sensed.

Moreover, in the foregoing embodiment, if a motion of the mobile communication terminal is sensed, the previous caller information is identified and an alarm operation is executed to recommend the user to call the previous caller. However, preset schedule information may be checked and, if it is determined that a schedule of the preset schedule information has expired, the alarm may also be executed to invite the user to call the previous caller.

Furthermore, a location of the mobile communication terminal may be identified and, if a change in the location of the mobile communication terminal is determined as well as a motion or movement of the mobile communication terminal is sensed, the alarm operation that recommends the user to call the caller may be executed. For example, if a location where the user sends the call reject message to the caller is a movie theater and it is determined that the location of the mobile communication terminal is not the movie theater, the alarm may be executed to recommends the user to call the previous caller.

Immediately before execution of the alarm operation that recommends the user to call the previous caller, it is determined whether there is a call log associated with the caller. If there is a call log that indicates that the user has already received or made a call from or to the previous caller, then the alarm may not be executed.

As is apparent from the foregoing description, by using the alarm method and apparatus for the mobile communication terminal, after a user rejects an incoming call or expresses an intention to call a caller back through a call reject message, the user is recommended to call the previous caller back through the alarm to assist to the user. More specifically, when the user rejects the incoming call or sends the call reject message to the caller because the user cannot receive the call, the mobile communication terminal recognizes when the user can return the call and provides a reminder to the user to call the previous caller back.

It can be seen that the various embodiments of the present disclosure may be implemented with hardware, software, or a combination of hardware and software. Such software may be stored in a volatile storage such as a RAM, a non-volatile storage such as a ROM a memory chip, a device, an integrated circuit, and an optically or magnetically recordable and machine (for example, computer)-readable storage medium such as a Compact Disc (CD), a Digital Versatile Disk (DVD), a magnetic disk, or a magnetic tape. It can be seen that the memory included in the mobile communication terminal is an example of a machine-readable storage medium which is suitable for storing a program or programs including instructions for implementing the various embodiments of the present disclosure. Therefore, the present disclosure includes a computer readable medium including codes for implementing an apparatus or method as described above. The computer readable medium may be electronically transferred through a medium such as a communication signal that is provided through a wired or a wireless connection.

While the present disclosure has been shown and described with reference to various embodiments thereof, it will be understood by those skilled in the art that various changes in form and detail may be made therein without departing from the spirit and scope of the present disclosure as defined by the appended claims and their equivalents.

What is claimed is:

1. A method for executing an alarm in a mobile communication terminal, the method comprising:
determining whether a call request reject occurs;
detecting at least one of preset schedule information, motion information of the mobile communication terminal, and location information of the mobile communication terminal from a time of the determining that the call request reject occurs; and
executing an alarm that recommends a user to call a caller of the call request reject based on the detected at least one information.

2. The method of claim 1, wherein the determining of whether the call request reject occurs comprises:
sending a call reject message to the caller by using a preset user manipulation; and
determining that the call request reject occurs when the call reject message is sent to the caller.

3. The method of claim 2, further comprising determining that the call request reject occurs when the call reject message is sent to the caller if a phone number of the caller is stored in advance in the mobile communication terminal.

4. The method of claim 1, wherein the executing of the alarm recommends the user to call the caller of the call request reject, based on the detected at least one information comprises:
executing the alarm that recommends the user to call the caller of the call request reject, when it is determined that a schedule of the preset schedule information ends.

5. The method of claim 1, wherein the executing of the alarm comprises:
executing the alarm when a motion of the mobile communication terminal is sensed after the elapse of a preset time from the time of determining that the call request reject occurs.

6. The method of claim 1, wherein the executing of the alarm comprises:
executing the alarm when a change in a location of the mobile communication terminal is sensed.

7. The method of claim 1, wherein the alarm comprises:
at least one of an operation of visually displaying an alarm on a screen of the mobile communication terminal, an operation of providing a vibration, an operation of outputting a predetermined voice, and an operation of outputting a predetermined sound.

8. The method of claim 1, further comprising:
cancelling the executing of the alarm if detecting a call log associated with the caller before detecting at least one of the preset schedule information, the motion information of the mobile communication terminal, and the location information of the mobile communication terminal.

9. The method of claim 1, further comprising:
executing the alarm when a predetermined time has elapsed from the time of determining that the call request reject occurs.

10. The method of claim 9, further comprising:
cancelling the executing the alarm if a call log associated with the caller is detected before a preset time has elapsed from the time of determining that the call request reject occurs.

11. An apparatus for executing an alarm in a mobile communication terminal, the apparatus comprising:
a communication module configured to transmit and receive a wireless signal; and
a controller configured to sense rejection of a call request signal of a caller received by the communication module, to detect at least one of preset schedule information, motion information of the mobile communication terminal, and location information of the mobile communication terminal from the time of the sensed rejection, and to execute an alarm that recommends a user to call the caller based on the detected at least one information.

12. The apparatus of claim 11, wherein the controller is configured to sense the rejection when a call reject message is sent to the caller by using a preset user manipulation.

13. The apparatus of claim 11, wherein the controller is configured to sense the rejection when a call reject message is sent to the caller if a phone number of the caller is stored in advance in the mobile communication terminal.

14. The apparatus of claim 11, wherein the controller is configured to execute the alarm when sensing that a schedule of the preset schedule information ends.

15. The apparatus of claim 11, wherein the controller is configured to execute the alarm when sensing a motion of the mobile communication terminal after the elapse of a preset time from the time of sensing rejection of the call request signal of the caller.

16. The apparatus of claim 11, wherein the controller is configured to execute the alarm when sensing a change in a location of the mobile communication terminal.

17. The apparatus of claim 11, wherein the alarm comprises at least one of an operation of visually displaying an alarm on a screen of the mobile communication terminal, an operation of providing a vibration, an operation of outputting a predetermined voice, and an operation outputting a predetermined sound.

18. The apparatus of claim 11, wherein the controller is configured to cancel the executing of the alarm when sensing a call log associated with the caller.

19. The apparatus of claim 11, wherein the controller is configured to execute the alarm when a preset time has elapsed from the time of the sensed rejection of the call request signal of the caller.

20. The apparatus of claim 19, wherein the controller is configured to cancel the executing of the alarm when a call log associated with the caller is sensed before the preset time has elapsed from the time of the sensed rejection of the call request signal of the caller.
